(19) United States
(12) Patent Application Publication
(10) Pub. No.: US 2005/0231584 A1
(43) Pub. Date: Oct. 20, 2005

(54) Ink and media sensing with a color sensor

(76) Inventors: Seela Raj D. Rajaiah, Penang (MY); Lye Hock Bernard Chan, Penang (MY)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/825,765

(22) Filed: Apr. 16, 2004

(51) Int. Cl. B41J 2/435

(52) U.S. Cl. 347/232; 347/233

(57) ABSTRACT

A printing device includes a controller, a light emitter and a color sensor. The controller controls print functions. The light emitter is situated to emit light on media fed into the printing device. The color sensor detects light from the light emitter reflecting off the media. The color sensor generates a feedback signal for use by the controller.

### BACKGROUND

Printing devices included in printers, photocopiers, facsimile machines, plotters and so on, are used to place information on media such as paper, fabrics, textile, etc. Modern printing devices often have one or more built-in sensors to perform one or more sensing tasks such as sensing media edge, sensing media type, sensing temperature, sensing humidity, sensing ink density, and so on.

Sensors can be used both during normal operation and during calibration. For example, a calibration operation may include printing of a test pattern followed by scanning the test pattern. The scanning can be performed with a light emitting diode that emits light over the test pattern and an optical sensor that detects the quantity of light reflected from the test pattern. From the reflected light, placement and drop volume and other characteristics of the applied ink can be assessed. The information gleaned from the scanning of the test pattern allows adjustments to be made to the printer. The adjustments include adjusting the firing time and volume of the ink placed on the media.

In the prior art, optical sensors have only detected the quantity of light and not been able to determine light color. As a result, information from optical sensors has not been optimal for performing some printer functions, such as printer color calibration.

### SUMMARY OF THE INVENTION

In accordance with an embodiment of the present invention a printing device includes a controller, a light emitter and a color sensor. The controller controls print functions. The light emitter is situated to emit light on media fed into the printing device. The color sensor detects light from the light emitter reflecting off the media. The color sensor generates a feedback signal for use by the controller.

### BRIEF DESCRIPTION OF THE DRAWINGS

FIG. 1 is a simplified block diagram of a sensor system used in a printing device, in accordance with an embodiment of the present invention.

FIG. 2 is simplified block diagram of a color sensor.

FIG. 3 is a simplified block diagram of a printing device.

### DESCRIPTION OF THE EMBODIMENT

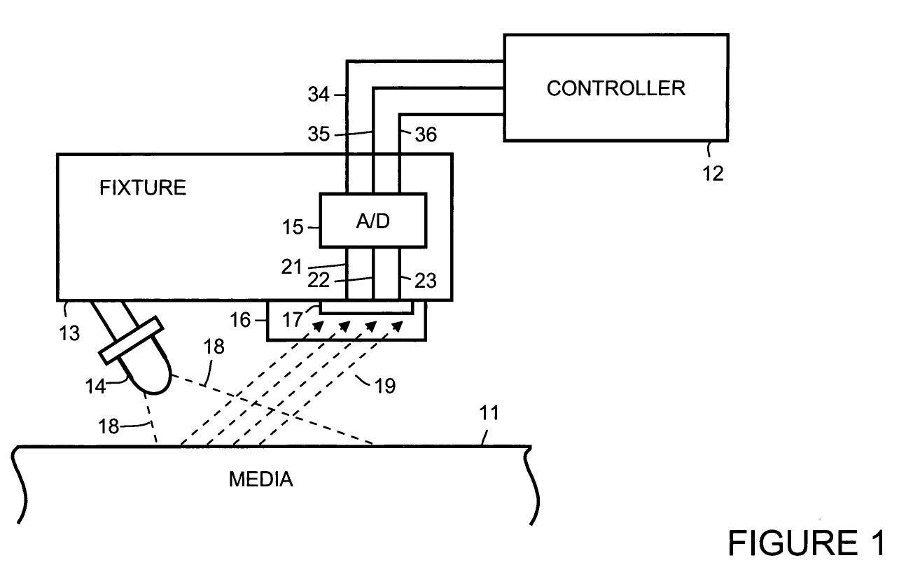

FIG. 1 is a simplified block diagram of a sensor system used in a printing device. The sensor system includes a light emitter 14 attached to a fixture 13. For example, light emitter 14 is a white light emitting diode (LED). Fixture 13 is, for example, a printhead in an inkjet printer. Alternatively, fixture 13 is a fixture dedicated to supporting scanning or is any available structure on a printing device on which light emitter 14 may be attached.

As represented by a light beam 18 and incident light 19, a portion of light emitted from light emitter 14 reflects off media 11, or ink on media 11, and is captured by a color sensor 17. For example, color sensor 17 is located within a transparent housing 16. An analog signal Vout (R) 21 for a red color signal, an analog signal Vout (G) 22 for a green color signal and an analog signal Vout (B) 23 for a blue color signal are received by an analog-to-digital converter (A/D) 15. A/D 15 produces a digital signal 34 for a red color signal, a digital signal 35 for a green color signal and a digital signal 36 for a blue color signal.

A controller 12 receives sensor feedback data consisting of digital signal 34, digital signal 35 and digital signal 36. Controller 12 uses the sensor feedback data, for example, to determine the size and location of ink dots on media 11, for sensing information about media 11 such as color, type and alignment, and/or for sensing information about color of ink dots on media 11. Based on the sensor feedback data, controller 11 makes adjustments to the printing device.

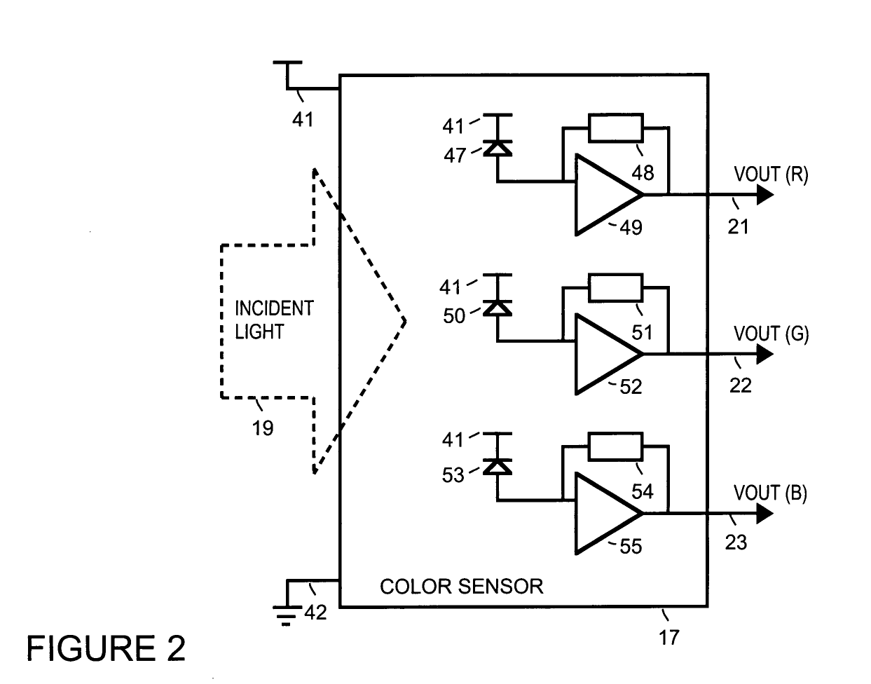

FIG. 2 is simplified block diagram of color sensor 13. Color sensor 13 receives a power input signal 41 and a ground input signal 42. For example, power input 41 is at 5.0 volts. For example, color sensor 13 has a spectral measurement of wavelength from 400 nanometers (nm) to 700 nm.

In response to incident light 19, color sensor 17 generates three separate output voltages (Vout): Vout (R) signal 21, Vout (G) signal 22 and Vout (B) signal 23. Vout (R) signal 21 is an analog signal that indicates the proportional red component of incident light 43 upon color sensor 17. For example, Vout (R) signal 21 is a DC voltage between 0 and 5 volts. Vout (G) signal 22 is an analog signal that indicates the proportional green component of incident light 43 upon color sensor 17. For example, Vout (G) signal 22 is a DC voltage between 0 and 5 volts. Vout (B) signal 23 is an analog signal that indicates the proportional blue component of incident light 43 upon color sensor 17. For example, Vout (B) signal 23 is a DC voltage between 0 and 5 volts.

Vout (R) signal 21 is generated by a photosensor 47, an amplifier 49 and a feedback resistor 48, which are all located within color sensor 17. Photosensor 47 includes an integrated color filter in red. Photosensor 47 is connected to power input signal 41.

Vout (G) signal 22 is generated by a photosensor 50, an amplifier 52 and a feedback resistor 51, which are all located within color sensor 17. Photosensor 50 includes an integrated color filter in green. Photosensor 50 is connected to power input signal 41.

Vout (B) signal 23 is generated by a photosensor 53, an amplifier 55 and a feedback resistor 54, which are all located within color sensor 17. Photosensor 53 includes an integrated color filter in blue. Photosensor 53 is connected to power input signal 41.

FIG. 2 presents only one example of implementation of color sensor 13. Alternative implementations can consist, for example, of discreet photosensors and filters, or color sensors integrated on CMOS, etc. Additionally, while color sensor 13 is shown implemented using the colors red, green and blue, different and/or additional colors can be used. For example, cyan, magenta and yellow sensors can be used instead of or in additional to red, green and blue sensors.

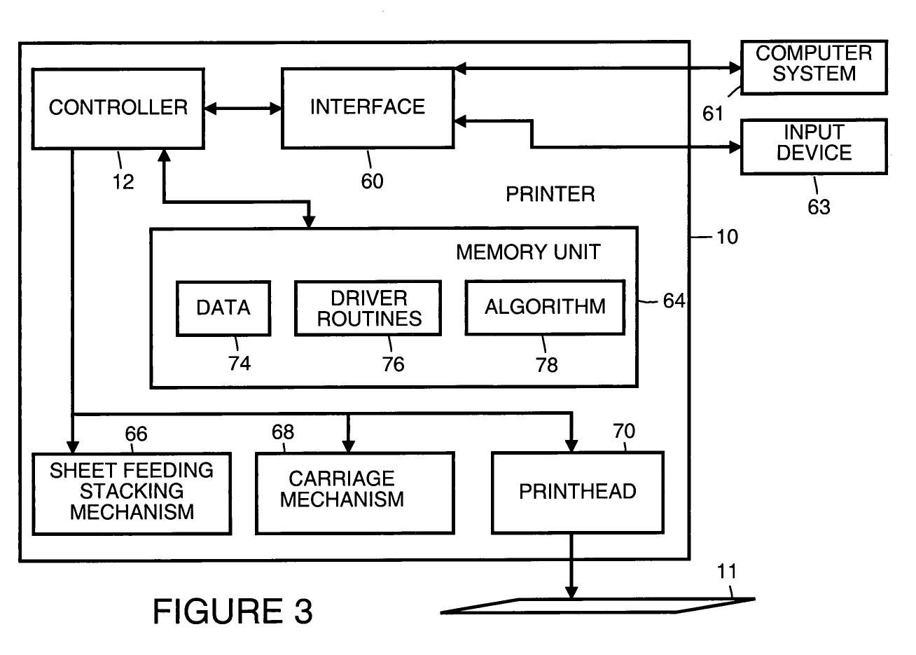

FIG. 3 is a simplified block diagram showing interaction of controller 12 with other elements of a printing device 10. Controller 12 is connected to a computer system 61 via an interface unit 60. The interface unit 60 facilitates the transferring of data and command signals to controller 12 for printing purposes. Interface unit 60 also enables printing device 10 to be electrically connected to an input device 63 for the purpose of downloading print image information to be printed on a print media 11. Input device 63 can be any type of peripheral device (e.g., a scanner or fax machine) that can be connected to printing device 10.

In order to store the data, at least temporarily, printing device 10 includes a memory unit 64. Memory unit 64 is divided into a plurality of storage areas that facilitate printer operations. The storage areas include a data storage area 74, driver routines storage 76, and algorithm storage area 78 that holds the algorithms that facilitate the mechanical control implementation of the various mechanical mechanisms of printing device 10.

Data area 74 receives data files that define the individual pixel values that are to be printed to form a desired object or textual image on media 11. Driver routines 76 contain printer driver routines. Algorithms 78 include the routines that control a sheet feeding stacking mechanism for moving a media 11 through the printing device from a supply or feed tray to an output tray and the routines that control a carriage mechanism that causes a printhead carriage unit to be moved across a print media 11 on a guide rod.

In operation, printing device 10 responds to commands by printing full color or black print images on print media 11. In addition to interacting with memory unit 64, controller 12 controls a sheet feeding stacking mechanism 66 and a carriage mechanism 68. Controller 12 also forwards printhead firing data to one or more printheads, represented in FIG. 3 by a printhead 70. The input data received at interface 60 includes, for example, information describing printed characters and/or images for printing. For example, input data may be in a printer format language such as Postscript, PCL 3, PCL 5, HPGL, HPGL 2 or some related version of these. Alternatively, the input data may be formatted as raster data or formatted in some other printer language. The printhead firing data sent to printhead 70 is used to control the ejection elements associated with the nozzles of an ink jet printer, such as for thermal ink jet printer, piezo ink jet printers or other types of printers.

Controller 12 uses sensor feedback data consisting of digital signal 34, digital signal 35 and digital signal 36 when controlling printing device 10. For example, based on the sensor feedback data, controller 12 varies algorithms that format data for printing to calibrate color of images printed on media 11. For example, based on the sensor feedback data, controller 12 varies control signals to printhead 70 to control ink emission, for example, by varying firing frequency and/or firing timing of nozzles within printhead 70. For example, based on the sensor feedback data, controller 12 can select nozzles to be used for printing. For example, based on the sensor feedback data, controller 12 can vary print settings to take into account misalignment of paper. For example, based on the sensor feedback data, controller 12 can vary print settings to take into account detected paper media type. For example, based on the sensor feedback data, controller 12 varies control signals to carriage mechanism 68 to vary firing alignment of media.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

1. A color calibration system within a printing device comprising:
a controller that controls print functions;
a light emitter situated to emit light on media fed into the printing device; and,
a color sensor that detects light from the light emitter reflecting off the media, the color sensor generating a feedback signal for use by the controller, the controller using the feedback signal for color calibration of images placed on the media.

2. A color calibration system as in claim 1 wherein the controller additionally uses the feedback signal for at least one of the following:
adjusting firing timing of a printhead;
adjusting ink volume placed on the media; and,
selecting nozzles to be used for printing.

3. A color calibration system as in claim 1 additionally comprising:
an analog-to-digital converter that converts the feedback signal from analog to digital before forwarding the feedback from the color sensor to the controller.

4. A color calibration system as in claim 1 wherein the color sensor detects the following colors: red, green and blue.

5. A color calibration system as in claim 1 wherein the light emitter is a white light emitting diode.

6. A printing device comprising:
a controller for controlling print functions;
a light emitter situated to emit light on media fed into the printing device; and,
a color sensor for detecting light from the light emitter reflecting off the media, the color sensor generating a feedback signal for use by the controller.

7. A printing device as in claim 6 wherein the controller uses the feedback signal in color calibration.

8. A printing device as in claim 6 wherein the controller additionally uses the feedback signal for at least one of the following:
adjusting firing timing of a printhead;
adjusting ink volume placed on the media; and,
selecting nozzles to be used for printing.

9. A printing device as in claim 6 additionally comprising:
an analog-to-digital converter that converts the feedback signal from analog to digital before forwarding the feedback from the color sensor to the controller.

10. A printing device as in claim 6 wherein the color sensor detects the following colors: red, green and blue.

11. A printing device as in claim 6 wherein the light emitter is a white light emitting diode.

12. A method for performing color calibration within a printing device, the method comprising:
printing information on media fed into the printing device;
emitting light onto the media;
detecting a plurality of colors of light reflected from the media; and,
adjusting color calibration of the printing device based on the detected plurality of colors.

13. A method as in claim 12, wherein detecting the plurality of colors of light includes the following:
generating a separate color signal for each detected color.

14. A method as in claim 12, wherein detecting the plurality of colors of light includes the following:
generating a separate analog color signal for each detected color; and,
converting the separate analog color signal for each detected color to a digital color signal.

15. A method as in claim 12 wherein the plurality of colors comprise red, green and blue.

16. A printing device comprising:
printing means for printing information on media fed into the printing device;
emitting means for emitting light onto the media;
detecting means for detecting a plurality of colors of light reflected from the media; and,
adjusting means for adjusting color calibration of the printing device based on the detected plurality of colors.

17. A printing device as in claim 16, wherein the detecting means includes:
a generating means for generating a separate color signal for each detected color.

18. A printing device as in claim 16, wherein the detecting means includes:
generating means for generating a separate analog color signal for each detected color; and,
converter means for converting the separate analog color signal for each detected color to a digital color signal.

19. A printing device as in claim 16 wherein the plurality of colors comprise red, green and blue.

20. A printing device as in claim 16 wherein the emitting means is a white light emitting diode.
